(19) United States
(12) Patent Application Publication
(10) Pub. No.: US 2016/0088352 A1
(43) Pub. Date: Mar. 24, 2016

(54) METHODS AND SYSTEMS FOR UPDATING USER PROFILES

(71) Applicant: Rovi Guides, Inc., Santa Clara, CA (US)

(72) Inventors: Akshat Agarwal, Delhi (IN); Abubakkar Siddiq, Methuen, MA (US)

(21) Appl. No.: 14/495,285

(22) Filed: Sep. 24, 2014

(51) Int. Cl. H04N 21/466; H04N 21/45; H04N 21/442

(52) U.S. Cl. CPC H04N 21/4667; H04N 21/44218; H04N 21/44222; H04N 21/4532; H04N 21/4662

(57) ABSTRACT

Methods and systems are described herein for a media guidance application that improves the reliability of data collected about a user, particularly when the user is consuming media content in a group. For example, in addition to monitoring content that a user (or a group of users) consumes (e.g., what television shows are viewed), the media guidance application may monitor the interactions the user (and/or each user in the group) has with the content. The media guidance application may then update a user profile based on the monitored interactions.

### BACKGROUND

In conventional systems, users have access to a plethora of media content. With so much content available, users often require assistance in selecting content, and content providers often require assistance in selecting what content to provide to a user. To aid in selecting content, systems often collect data related to what content a user watches (or does not watch), what content that a user enjoys (or dislikes), etc. and stores this information in a user profile. Despite the advantages of creating a user profile, most users are not motivated or are otherwise unwilling to manually submit data for the user profile. Furthermore, while data about a user may be collected passively, such passively collected data is often unreliable, particularly when a user is consuming content in a group.

### SUMMARY

Accordingly, methods and systems are described herein for a media guidance application that improves the reliability of data collected about a user, particularly when the user is consuming media content in a group. For example, in addition to monitoring content that a user (or a group of users) consumes (e.g., what television shows are viewed), the media guidance application may monitor the interactions the user (and/or each user in the group) has with the content. The media guidance application may then update a user profile based on the monitored interactions.

For example, the media guidance application may monitor a user to determine how much eye contact a user made with a display device while consuming a media asset (e.g., in order to determine whether or not the user is interested in the media asset). In another example, the media guidance application may monitor a user to determine whether or not a user is preoccupied with a device other than the device presenting a media asset. In yet another example, the media guidance application may monitor how much a user is talking (and/or whether a user is discussing the media asset) while the media asset is presented to a user in order to determine whether or not the user is interested in the media asset. Based on such data, the media guidance application may determine to update (or determine an amount at which to update) a user profile associated with the user.

For example, if the media guidance application determines that although a user consumed a media asset the user was not interested in the media asset, the media guidance application may determine to update (or not update) a user profile based on the user consuming the media asset. Furthermore, if a first user is consuming a media asset with a group, the media guidance application may determine that the selection of the media asset was based on the user preferences of the other users in the group. Therefore, the media guidance application may limit the amount that a user profile about the first user is updated based on the first user consuming the media asset. The media guidance application may use numerous techniques to discern which users in a group should have their respective user profiles updated (and by how much).

In some aspects, media guidance application may identify a first user and a second user within a viewing area of media content. For example, the media guidance application may use a detection module (e.g., featuring object recognition capabilities) to identify (e.g., the number as well as the names of) one or more users that are consuming the media content presented on a display device (e.g., a television).

The media guidance application may determine a first interaction level for the first user and a second interaction level for the second user. For example, the media guidance application may determine whether or not (and/or to what extent) the users are making eye contact, discussing the media content, using devices that may distract the users from the media content, etc. The media guidance application may use these determinations to arrive at an interaction level for each user.

For example, the interaction level for the first user may be based on whether the first user is controlling a user device that is presenting the media content; may be based on whether or not (or the frequency at which) a gaze point of the first user is fixated on a user device that is presenting the media content; may be based on whether or not (or the amount at which) the first user is discussing the media content (or not discussing the media content); may be based on whether or not the first user is interacting with a user device that is not presenting the media content; may be based on whether or not a user is conversing with and/or directing instructions toward the user device; and/or may be based on whether or not the first user is controlling a device presenting the media content.

The media guidance application may then rank the first user and the second user based on the first interaction level and the second interaction level. For example, the media guidance application may determine which users are more or less interested in the media content. Furthermore, the media guidance application may determine how interested each user is relative to the other users.

The media guidance application may determine a first weight based on the rank of the first user. For example, based on the interaction level of the first user (or the level of interest the first user has in the media content, the amount of control the first user has in the selection of the media content, etc. that the interaction level represents), the media guidance application may select how much a user profile for that user should be updated. For example, the amount of each weight may correspond to the level of interest the user has in the media content, the activeness of the user in the selection of the media content, etc.).

For example, in some embodiments, the media guidance application may cross-reference the rank of the first user with a database listing degrees to which a user profile should be updated and a rank corresponding to each of the degrees to determine the degree to which the first user profile is updated. For example, the weight selected by the media guidance application may correspond to the degree output by the database that corresponds to the rank of the user.

The media guidance application may then update a first user profile for the first user with information related to the media content, in which a degree to which the first user profile is updated is based on the first weight. For example, if a user has a high interaction level (e.g., corresponding in the user being very interested in the media content, the user being active in the selection of the media content, etc.), the media guidance application may effect a user profile more than if a user has a low interaction level (e.g., corresponding in the user being very interested in the media content, the user being active in the selection of the media content, etc.).

In some embodiments, the media guidance application may also determine a second weight based on the rank of the second user and update a second user profile for the second user with information related to the media content, in which a degree to which the second user profile is updated is based on the second weight. For example, the degree to which the second user profile is updated may correspond to the level of interest the second user has in the media content, the activeness of the second user in the selection of the media content, etc.

In some embodiments, the media guidance application may compare the rank of the first user to a threshold rank and update the first user profile in response to determining that the rank of the first user exceeds the threshold rank. For example, the media guidance application may determine that only users with rankings in the top half of the group may have their respective user profiles updated.

In some embodiments, the media guidance application may compare the first interaction level to a threshold interaction level and update the first user profile in response to determining that the first interaction level exceeds the threshold interaction level. For example, the media guidance application may determine that only users with interaction levels in the top half of the group may have their respective user profiles updated.

It should be noted that the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a display screen generated by a media guidance application in accordance with some embodiments of the disclosure;

FIG. 2 shows another illustrative example of a display screen generated by a media guidance application in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 shows an illustrative example of a detection module used to determine an interaction level of a user in accordance with some embodiments of the disclosure;

FIG. 6 is a flowchart of illustrative steps for determining whether or not to update a user profile in accordance with some embodiments of the disclosure; and

FIG. 7 is a flowchart of illustrative steps for determining criteria upon which to base a decision on whether or not to update of a user profile in accordance with some embodiments of the disclosure.

### DETAILED DESCRIPTION OF THE DRAWINGS

Methods and systems are described herein for a media guidance application that improves the reliability of data collected about a user, particularly when the user is consuming media content in a group. For example, in addition to monitoring content that a user (or a group of users) consumes (e.g., what television shows are viewed), the media guidance application may monitor the interactions the user (and/or each user in the group) has with the content. The media guidance application may then update a user profile based on the monitored interactions.

As referred to herein, an interactive media guidance application or, sometimes, a media guidance application or a guidance application is an application that provides media guidance through an interface that allows users to efficiently navigate content selections and/or easily identify content that they may desire. Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content.

In some embodiments, the media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application creates, stores, and/or updates a user profile. As referred to herein, a “user profile” is a collection of data associated with one or more people, groups of people, and/or other entity. For example, a user profile associated with a first user may include information related to the consumption of media content by the user. For example, the user profile may indicate what media content the user prefers (or dislikes), when the user typically consumes (or does not consume) media content, where a user typically consumes (or does not consume) media content, how (e.g., on what devices, in what formats, etc.) the user typically consumes (or does not consume) media content. The user profile may also include information about the user that is partially, tangentially, and/or completely related/unrelated to the consumption of media content (e.g., socio-economic information and/or demographic information about the user, purchasing habits, daily routines, known associations, etc.).

To amass the information about a user in the user profile, the media guidance application may monitor a user, receive (directly or indirectly) information about the user, and/or consult third-party databases or information sources. For example, the media guidance application may monitor a user using a detection module incorporated into or accessible by the media guidance application. The detection module may directly observe and record media content consumed by the user, interactions of the user while consuming the media content, and/or any other information for use in populating the user profile.

In another example, the media guidance application may receive information directly from a user (e.g., manual submissions) in response to queries, questionnaires, calibrations, etc. Alternatively or additionally, the media guidance application may receive information indirectly from a user. For example, the media guidance application may receive credit card purchase information, online submissions of information, etc. from the respective sources of such information.

In yet another example, the media guidance application may access databases of information (or other user profiles) associated with a user. For example, the media guidance application may query a central repository of consumer information and request information on the first user. Alternatively or additionally, the media guidance application may link to other user profiles and/or accounts (e.g., social networking accounts) associated with a user in order to compile information.

When monitoring a user, the media guidance application may receive numerous types of data that may be used to directly populate a user profile (e.g., whether or not a user consumed a particular media asset) and/or determine an interaction level of the user with consumed media content. Alternatively, the media guidance application may receive data that is used to infer interaction levels, relationships, user preferences, or other information that itself is used to determine whether or not to update a user profile.

As used herein, an “interaction level” is a qualitative or quantitative expression of whether or not (or a degree to which) a user should be accountable for the media content being presented. For example, if a user is consuming a media asset, the user profile associated with the user should be updated to reflect the fact that the media asset was consumed by the user. However, if the user did not select the media content, was not paying attention to the media asset, and/or did not otherwise interact with the media asset, then the media guidance application may adjust the amount to which the user profile is updated (if any).

For example, the media guidance application may monitor a user to determine whether or not the user is responsible for the selection of the media content currently being presented. For example, the media guidance application may determine whether or not the user (as opposed to another user) selected the media content and/or controls (e.g., is holding) a device (e.g., a remote control) used to select the media content.

In another example, the media guidance application may monitor a user to determine whether or not the user is conversing with and/or directing instructions toward the user device. For example, the media guidance application may determine whether or not the intention of the user is to issue instructions and/or control a user device.

In another example, the media guidance application may monitor the user to determine whether or not the user is paying attention to the media content presented. For example, the media guidance application may monitor a user to determine whether or not a user is preoccupied with a second device as opposed to a first device that is presenting a media asset. For example, the media guidance application may determine that if a user is using a second device (e.g., a tablet computer), the media guidance application may lower (e.g., by an amount associated with the determination) the determined interaction level of the user because the user is preoccupied with the second device. Alternatively, the media guidance application may determine that the second device is also presenting content related to the media asset presented on the first device (e.g., extra features, promotional information, etc.). Accordingly, the media guidance application may raise (e.g., by an amount associated with the determination) the interaction level of the user. Alternatively or additionally, the media guidance application may determine that the second device is used to control (e.g., select the media asset for display from a plurality of media assets) the first device. Accordingly, the media guidance application may raise (e.g., by an amount associated with the determination) the interaction level of the user.

In yet another example, the media guidance application may monitor a user to determine whether or not a user is talking while a media asset is presented on a first device. For example, the media guidance application may determine that, if a user is talking while the media asset is being presented on the first device, the user is paying less attention to the media asset presented on the first device. Accordingly, the media guidance application may lower (e.g., by an amount associated with the determination) the determined interaction level of the user. Alternatively, the media guidance application may determine that, although the user is talking while the media asset is being presented, the user is talking about the media asset being presented. Accordingly, the media guidance application may raise (e.g., by an amount associated with the determination) the interaction level of the user. Alternatively or additionally, the media guidance application may determine that, while the user is talking about the media asset being presented, the user is stating that he or she does not like the media asset. Accordingly, the media guidance application may lower (e.g., by an amount associated with the determination) the interaction level of the user.

In some embodiments, the media guidance application may compare values associated with monitored data to threshold values. For example, the media guidance application may monitor a user to determine how much eye contact a user made with a display device while consuming a media asset. The media guidance application may record the frequency at which the user made eye contact with the display device outputting the media content. This information may be recorded in the user profile. Additionally, the media guidance application may compare the frequency at which the user made eye contact with the display device outputting the media content to a threshold frequency. For example, the threshold frequency may indicate a typical amount of eye contact that a normal user (or a user of a similar demographic or other group as the current user) makes during the current media content, makes when the user enjoys (or does not enjoy), etc. The media guidance application may compare the monitored frequency to the threshold frequency, and record the results of the comparison in the user profile. For example, if the monitored frequency is greater than the threshold frequency, the media guidance application may determine the user is interested in the media content. The media guidance application may then record this determination in the user profile.

It should be noted that throughout this disclosure numerous “thresholds” may be discussed. As described herein, a threshold is a value that may be compared to another value (or a corresponding unit of measure) in order to determine whether or not a condition has been met and/or a function should be performed. For example, a monitored interaction level may be compared to a threshold interaction level in order to determine whether or not the monitored interaction level corresponds to updating a user profile (e.g., whether or not the monitored interaction level exceeds the threshold interaction level). In such an example, the unit of measure of the interaction level and the threshold interaction level may both correspond to a particular level of eye contact, whether or not a user was holding or not holding a control device for a display device presenting media content, etc.

The particular values (e.g., expressed as either quantitative or qualitative terms) may be determined by the media guidance application based on prior user history (e.g., of the current user and/or a group of users). Alternatively or additionally, the media guidance application may receive a set of threshold values from a remote source. The values may be based on any criteria (e.g., industry standards, consumer reviews, user trends, etc.).

Based on the monitored data, the media guidance application may determine whether or not to update a user profile associated with the user. For example, if the media guidance application determines that, although a user consumed a media asset, the user was not interested in the media asset, the media guidance application may determine to update (or not update) a user profile based on the user consuming the media asset. Furthermore, if a first user is consuming a media asset with a group, the media guidance application may determine that the selection of the media asset was based on the user preferences of the other users in the group. Therefore, the media guidance application may limit the amount that a user profile about the first user is updated based on the first user consuming the media asset. The media guidance application may use numerous techniques to discern which users in a group should have their respective user profiles updated (and by how much).

For example, the media guidance application may determine a number of users within a viewing area of a display device. As referred to herein, a “viewing area” is an area in which users consuming media on a display device are typically situated. A viewing area may be expressed in terms of particular structures (e.g., a room, house, etc.), may be defined as a distance (e.g., feet, meters, etc.) from a display device, or may be defined in terms of the accessibility of a media content (e.g., whether or not a user may connect to a router used to access the media content). Furthermore, the viewing area may be limited (or expanded) based on the location of objects that may affect the ability of a user to view a display device while in a viewing area (e.g., walls, doors, windows, etc.).

The media guidance application may then determine an interaction level for each user in the viewing area. For example, the media guidance application may determine whether or not (and/or to what extent) the users are making eye contact, discussing the media content, using devices that may distract the users from the media content, etc.

The media guidance application may then determine how accountable each user in the viewing area is for the presentation of the media content that is being presented. For example, the media guidance application may rank the first user and the second user based on the first interaction level and the second interaction level. For example, the media guidance application may determine which users are more or less interested in the media content. Furthermore, the media guidance application may determine how interested each user is relative to the other users.

The media guidance application may update a respective user profile for each user commiserate with the rank. For example, the media guidance application may determine a first weight based on the rank of the first user. For example, based on the interaction level of the first user (or the level of interest the first user has in the media content, the amount of control the first user has in the selection of the media content, etc. that the interaction level represents), the media guidance application may select how much a user profile for that user should be updated. For example, the amount of each weight may correspond to the level of interest the user has in the media content, the activeness of the user in the selection of the media content, etc.).

For example, in some embodiments, the media guidance application may cross-reference the rank of the first user with a database listing degrees to which a user profile should be updated and a rank corresponding to each of the degrees to determine the degree to which the first user profile is updated. For example, the weight selected by the media guidance application may correspond to the degree of output by the database that corresponds to the rank of the user.

The media guidance application may then update a first user profile for the first user with information related to the media content, in which a degree to which the first user profile is updated is based on the first weight. For example, if a user has a high interaction level (e.g., corresponding in the user being very interested in the media content, the user being active in the selection of the media content, etc.), the media guidance application may effect a user profile more than if a user has a low interaction level (e.g., corresponding in the user being very interested in the media content, the user being active in the selection of the media content, etc.).

In some embodiments, the media guidance application may also determine a second weight based on the rank of the second user and update a second user profile for the second user with information related to the media content, in which a degree to which the second user profile is updated is based on the second weight. For example, the degree to which the second user profile is updated may correspond to the level of interest the second user has in the media content, the activeness of the second user in the selection of the media content, etc.).

In some embodiments, the media guidance application may compare the rank of the first user to a threshold rank and update the first user profile in response to determining that the rank of the first user exceeds the threshold rank. For example, the media guidance application may determine that only users with rankings in the top half of the group may have their respective user profiles updated.

In some embodiments, the media guidance application may compare the first interaction level to a threshold interaction level and update the first user profile in response to determining that the first interaction level exceeds the threshold interaction level. For example, the media guidance application may determine that only users with interaction levels in the top half of the group may have their respective user profiles updated.

As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

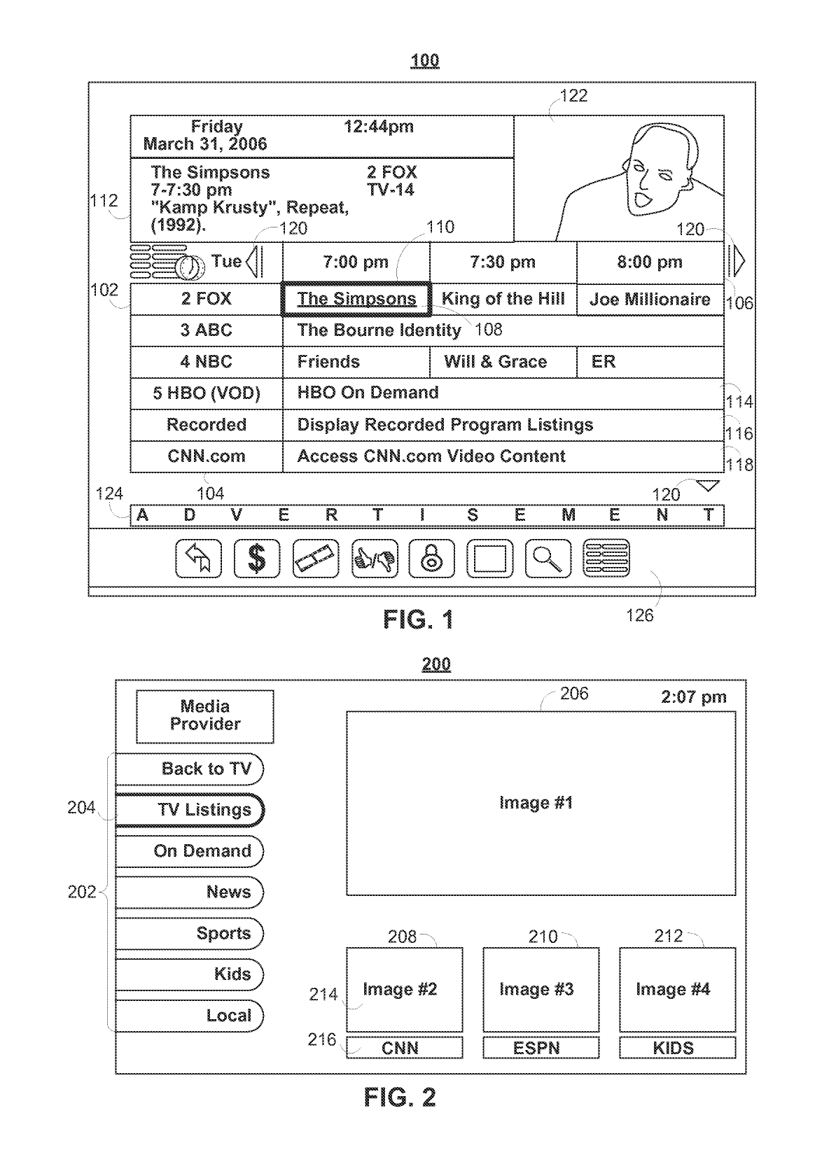

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 1 shows illustrative grid of a program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, I I I et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

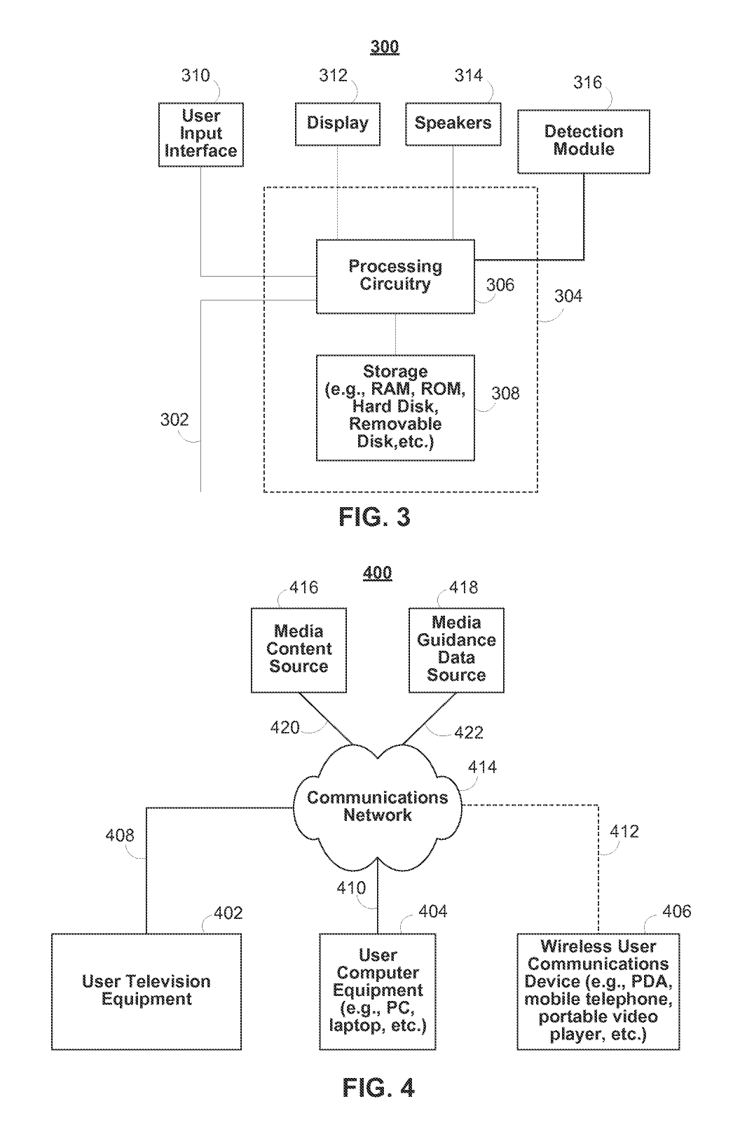

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300, also referred to as user device 300, may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user device 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user device 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 310 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

User equipment device 300 may also incorporate or be accessible to detection module 316. Detection module 316 may further include various components (e.g., a video detection component, an audio detection component, object recognition module, etc.). In some embodiments, detection module 316 may include components that are specialized to generate particular information (e.g., an interaction level of a user, the content of a media asset, etc.).

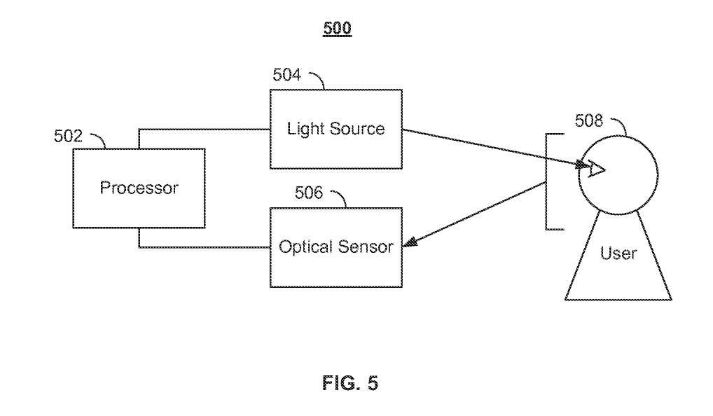

For example, as discussed below in relation to FIG. 5, detection module 316 may include an eye contact detection component, which determines or receives a location upon which one or both of a user's eyes are focused, to determine an interaction level of the user. The location upon which a user's eyes are focused is referred to herein as the user's “gaze point.” In some embodiments, the eye contact detection component may monitor one or both eyes of a user of user device 300 to identify a gaze point of the user. The eye contact detection component may additionally or alternatively determine whether one or both eyes of the user are focused on display 312 (e.g., indicating that a user is viewing display 312) or focused on a location that is not on display 312 (e.g., indicating that a user is not viewing display 312). In some embodiments, the eye contact detection component includes one or more sensors that transmit data to processing circuitry 306, which determines a user's gaze point. The eye contact detection component may be integrated with other elements of user equipment device 300, or the eye contact detection component, or any other component of detection module 316, and may be a separate device or system in communication with user equipment device 300.

In some embodiments, detection module 316 may include a content recognition module. The content recognition module may use object recognition techniques such as edge detection, pattern recognition, including, but not limited to, self-learning systems (e.g., neural networks), optical character recognition, on-line character recognition (including but not limited to, dynamic character recognition, real-time character recognition, intelligent character recognition), and/or any other suitable technique or method to determine the interactions of a user with media content. For example, the media application may receive data in the form of a video of the user. The video may include a series of frames. For each frame of the video, the media application may use a content recognition module or algorithm to determine the people (e.g., the number of users in a viewing area) in each of the frames or series of frames and/or the interaction level of those people. For example, the media guidance application may use the content recognition module to determine whether or not a user is using a second device, whether or not the second device is accessing content associated with the media content presented on a first device, etc.

Additionally or alternatively, the content recognition module and object recognition techniques discussed above may be applied to one or more frames, playback positions, etc. of a media asset to determine the content of the media asset, or a segment of a media asset, and/or any other information for use in updating a user profile. For example, in response to determining that a user has a high interaction level, the media guidance application may update a user profile with information that indicates the user enjoys the genre of the current media content.

In some embodiments, the content recognition module or algorithm may also include speech recognition techniques, including but not limited to Hidden Markov Models, dynamic time warping, and/or neural networks (as described above) to translate spoken words into text and/or processing audio data. The content recognition module may also combine multiple techniques to determine the interaction of a user and/or the content of a media asset. For example, the media guidance application may determine whether or not a user is speaking and/or about what the user is speaking.

In addition, the media application may use multiple types of optical character recognition and/or fuzzy logic, for example, when processing keyword(s) retrieved from data (e.g., textual data, translated audio data, user inputs, etc.) describing the interaction level of a user (or when cross-referencing various types of data in databases). For example, if the particular data received is textual data, using fuzzy logic, the media application (e.g., via a content recognition module or algorithm incorporated into, or accessible by, the media application) may determine two fields and/or values to be identical even though the substance of the data or value (e.g., two different spellings) is not identical.

It should be noted that detection module 316 may, in some embodiments, be located on a separate device in communication with the device upon which a media guidance application (and control circuitry 304) is implemented. For example, in some embodiments, detection module 316 may communicate with user device 300 via a communications network (e.g., communications network 414 (FIG. 4)).

The guidance application may be implemented using any suitable architecture. For example, it may be a stand-alone application wholly implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on user equipment device 300. This way, the processing of the instructions is performed remotely by the server while the resulting displays are provided locally on user equipment device 300. User equipment device 300 may receive inputs from the user via input interface 310 and transmit those inputs to the remote server for processing and generating the corresponding displays. For example, user equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to user equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates the likelihood that a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions and advertisements that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

FIG. 5 is an illustrative example of one component of a detection module (e.g., detection module 316 (FIG. 3)), which may be accessed by a media guidance application in accordance with some embodiments of the disclosure. FIG. 5 shows eye contact detection component 500, which may be used to identify the gaze point of a user of user device 300, in order to determine the interaction level of the user. For example, the location upon which a user's eyes are focused may indicate whether or not a user is paying (or the amount a user is paying) attention to the media guidance application. For example, eye contact detection component 500 may determine whether one or both eyes of the user are focused on the display (e.g., display 312 (FIG. 3)) associated with the media guidance application (e.g., indicating that a user is attentive) or focused on a location that is not on the display (e.g., indicating that a user is not attentive).

Eye contact detection component 500 includes processor 502, light source 504, and optical sensor 506. Light source 504 transmits light that reaches at least one eye of a user, and optical sensor 506 is directed at the user to sense reflected light. Optical sensor 506 transmits collected data to processor 502, and based on the data received from optical sensor 506, processor 502 determines a user's gaze point.

In some embodiments, eye contact detection component 500 is configured for determining a gaze point of a single user. In other embodiments, eye contact detection component 500 may determine gaze points for a plurality of users. Eye contact detection component 500 may identify multiple users of user devices (e.g., user equipment device 300 (FIG. 3)).

Processor 502 may be integrated with one or more light sources 504 and one or more optical sensors 506 in a single device. Additionally or alternatively, one or more light sources 504 and one or more optical sensors 506 may be housed separately from processor 502 and in wireless or wired communication with processor 502. One or more of processors 502, light sources 504, and optical sensors 506 may be integrated into a user device (e.g., user equipment device 300 (FIG. 3)).

Processor 502 may be similar to processing circuitry 306 (FIG. 3) described above. In some embodiments, processor 502 may be processing circuitry 306 (FIG. 3), with processing circuitry 306 in communication with light source 504 and optical sensor 506. In other embodiments, processor 502 may be separate from but optionally in communication with processing circuitry 306.

Light source 504 transmits light to one or both eyes of one or more users. Light source 504 may emit, for example, infrared (IR) light, near infrared light, or visible light. The light emitted by light source 504 may be collimated or non-collimated. The light is reflected in a user's eye, forming, for example, the reflection from the outer surface of the cornea (i.e., a first Purkinje image), the reflection from the inner surface of the cornea (i.e., a second Purkinje image), the reflection from the outer (anterior) surface of the lens (i.e., a third Purkinje image), and/or the reflection from the inner (posterior) surface of the lens (i.e., a fourth Purkinje image).

Optical sensor 506 collects visual information, such as an image or series of images, of one or both of one or more users' eyes. Optical sensor 506 transmits the collected image(s) to processor 502, which processes the received image(s) to identify a glint (i.e., corneal reflection) and/or other reflection in one or both eyes of one or more users. Processor 502 may also determine the location of the center of the pupil of one or both eyes of one or more users. For each eye, processor 502 may compare the location of the pupil to the location of the glint and/or other reflection to estimate the gaze point. Processor 502 may also store or obtain information describing the location of one or more light sources 504 and/or the location of one or more optical sensors 506 relative to a display (e.g., display 312 (FIG. 3)). Using this information, processor 502 may determine a user's gaze point on a display (e.g., display 312 (FIG. 3)), or processor 502 may determine whether or not a user's gaze point is the display (e.g., display 312 (FIG. 3)).

In some embodiments, eye contact detection component 500 performs best if the position of a user's head is fixed or relatively stable. In other embodiments, eye contact detection component 500 is configured to account for a user's head movement, which allows the user a more natural viewing experience than if the user's head were fixed in a particular position.

In some embodiments accounting for a user's head movement, eye contact detection component 500 includes two or more optical sensors 506. For example, two cameras may be arranged to form a stereo vision system for obtaining a 3D position of the user's eye or eyes; this allows processor 502 to compensate for head movement when determining the user's gaze point. The two or more optical sensors 506 may be part of a single unit or may be separate units. For example, a user device (e.g., user equipment device 300 (FIG. 3)) may include two cameras used as optical sensors 506, or eye contact detection component 500 in communication with the user device (e.g., user equipment device 300 (FIG. 3)) may include two optical sensors 506. In other embodiments, each of the user device (e.g., user equipment device 300 (FIG. 3)) and eye contact detection component 500 may include an optical sensor, and processor 502 receives image data from the optical sensor of the user device and the optical sensor of eye contact detection component 500. Processor 502 may receive data identifying the location of optical sensor 506 relative to a display (e.g., display 312 (FIG. 3)) and/or relative to each other and use this information when determining the gaze point.

In other embodiments accounting for a user's head movement, eye contact detection component 500 includes two or more light sources for generating multiple glints. For example, two light sources 504 may create glints at different locations of an eye; having information on the two glints allows the processor to determine a 3D position of the user's eye or eyes, allowing processor 502 to compensate for head movement. Processor 502 may also receive data identifying the location of light sources 504 relative to a display (e.g., display 312 (FIG. 3)) and/or relative to each other and use this information when determining the gaze point.

In some embodiments, other types of eye contact detection components that do not utilize a light source may be used. For example, optical sensor 506 and processor 502 may track other features of a user's eye, such as the retinal blood vessels or other features inside or on the surface of the user's eye, and follow these features as the eye rotates. Any other equipment or method for determining one or more users' gaze point(s) not discussed above may be used in addition to or instead of the above-described embodiments of eye contact detection component 500.

It should be noted that eye contact detection component 500 is but one type of component that may be incorporated into or accessible by detection module 316 (FIG. 3) or the media application. Other types of components, which may generate other types of data (e.g., video, audio, textual, etc.), are fully within the bounds of this disclosure.

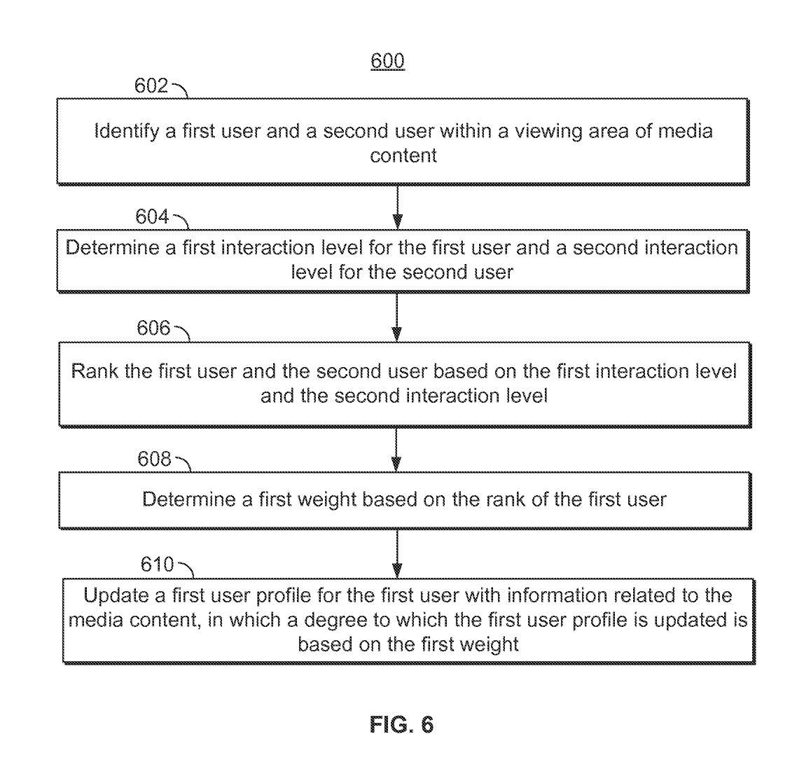

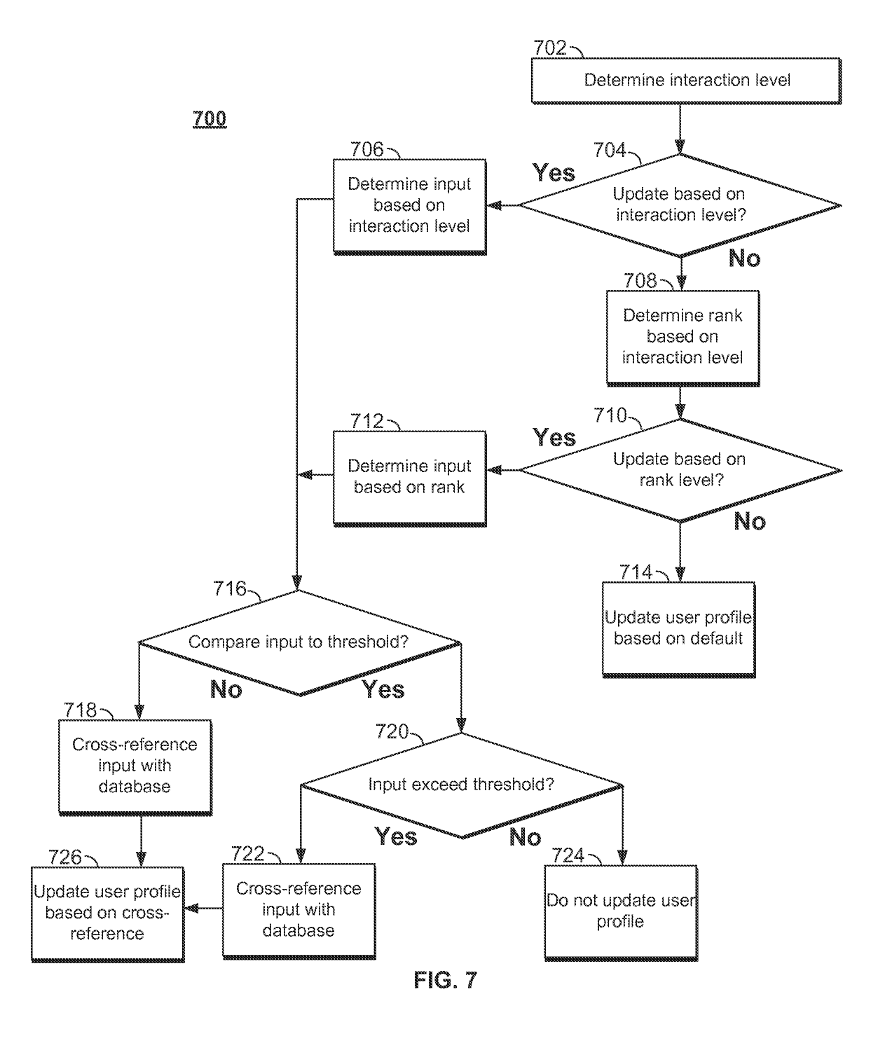

FIG. 6 is a flowchart of illustrative steps for determining whether or not to update a user profile. It should be noted that process 600 or any step thereof could be performed on, or provided by, any of the devices shown in FIGS. 3-4. For example, process 600 may be executed by control circuitry 304 (FIG. 3) as instructed by a media guidance application implemented on user equipment 402, 404, and/or 406 (FIG. 4) in order to determine whether or not to update a user profile. In addition, one or more steps of process 600 may be incorporated into or combined with one or more steps of any other process or embodiment (e.g., process 700 (FIG. 7)).

At step 602, media guidance application identifies (e.g., via control circuitry 304 (FIG. 3)) a first user and a second user within a viewing area of media content. For example, the media guidance application may use a detection module (e.g., detection module 316 (FIG. 3)) to identify (e.g., the number as well as the names of) one or more users that are consuming the media content presented on a display device (e.g., display 312). For example, the media guidance application (e.g., implemented on user device 300 (FIG. 3) and/or user equipment device 402, 404, and/or 406 (FIG. 4)) may determine (e.g., via control circuitry 304 (FIG. 3)) that a group or users is currently within a viewing area (e.g., a living room) that features a display device (e.g., user equipment device 402, 404, and/or 406 (FIG. 4)), in which the display device is presenting media content (e.g., a horror movie).

At step 604, the media guidance application determines (e.g., via control circuitry 304 (FIG. 3)) a first interaction level for the first user and a second interaction level for the second user. For example, the media guidance application may determine (e.g., via control circuitry 304 (FIG. 3)) whether or not (and/or to what extent) the users are making eye contact, discussing the media content, using devices that may distract the users from the media content, controlling a device (e.g., a remote control) used to control the device upon which the media content is presented, etc. The media guidance application may use these determinations to arrive at an interaction level for each user.

For example, the media guidance application may determine (e.g., via control circuitry 304 (FIG. 3)) the interaction level for the first user based on whether or not the first user is controlling a user device (e.g., holding a remote control) that is presenting the media content, based on whether or not (or the frequency at which) a gaze point of the first user is fixated on a user device (e.g., display 312) that is presenting the media content, based on whether or not (or the amount at which) the first user discussing the media content (or not discussing the media content), and/or based on whether or not the first user is interacting with a user device that is not presenting the media content.

At step 606, the media guidance application ranks the first user and the second user based on the first interaction level and the second interaction level. For example, the media guidance application may determine (e.g., via control circuitry 304 (FIG. 3)) which users are more or less interested in the media content, which users are more or less responsible for the media content being presented (as opposed to other media content), which users are enjoying (or not enjoying) the media content, etc. Furthermore, the media guidance application may determine how interested each user is relative to the other users.

Alternatively or additionally, the media guidance application may assign a value (e.g., a percentage or other designation) to each user based on the interaction level. For example, the media guidance application may assign a low value to users exhibiting a low interaction level. In contrast, the media guidance application may assign a high value to users exhibiting a high interaction level. The value assigned to each user may be relative to the number of users currently in the viewing area of the display device (e.g., display 312 (FIG. 3)). For example, the media guidance application may divide the responsibility and/or accountability of the media content being presented between each of the users (e.g., each user may be assigned a percentage of accountability, the sum of which equals one).

At step 608, the media guidance application determines (e.g., via control circuitry 304 (FIG. 3)) a first weight based on the rank of the first user. For example, based on the interaction level of the first user (or the level of interest the first user has in the media content, the amount of control the first user has in the selection of the media content, etc., that the interaction level represents), the media guidance application may select how much a user profile for that user should be updated. For example, the amount of each weight may correspond to the level of interest the user has in the media content, the activeness of the user in the selection of the media content, etc.).

For example, in some embodiments, the media guidance application (e.g., via control circuitry 304 (FIG. 3)) may cross-reference the rank of the first user with a database listing degrees to which a user profile should be updated and a rank corresponding to each of the degrees to determine the degree to which the first user profile is updated. For example, the weight selected by the media guidance application may correspond to the degree output by the database that corresponds to the rank of the user.

At step 610, the media guidance application updates (e.g., via control circuitry 304 (FIG. 3)) a first user profile (e.g., stored in storage 308 (FIG. 3) and/or any location accessible via communications network 414 (FIG. 4)) for the first user with information related to the media content, in which a degree to which the first user profile is updated is based on the first weight. For example, if a user has a high interaction level (e.g., corresponding in the user being very interested in the media content, the user being active in the selection of the media content, etc.), the media guidance application may affect a user profile more than if a user has a low interaction level (e.g., corresponding in the user being very interested in the media content, the user being active in the selection of the media content, etc.). In some embodiments, the weight (e.g., discussed in relation to step 608) may correspond to a percentage assigned to the user (e.g., as described in relation to step 606). For example, if the media guidance application determines (e.g., via control circuitry 304 (FIG. 3)) that a first user is only fifty percent responsible for the media content that is currently being presented, the media guidance application may only update the user profile by an amount that is half of the amount that the user profile would have been updated if the user was one-hundred percent responsible for the media content.

In some embodiments, the media guidance application may also determine (e.g., via control circuitry 304 (FIG. 3)) a second weight based on the rank of the second user and update a second user profile for the second user with information related to the media content, in which a degree to which the second user profile is updated is based on the second weight. For example, the degree to which the second user profile is updated may correspond to the level of interest the second user has in the media content, the activeness of the second user in the selection of the media content, etc.).

In some embodiments, the media guidance application may compare (e.g., via control circuitry 304 (FIG. 3)) the rank of the first user to a threshold rank and update the first user profile in response to determining that the rank of the first user exceeds the threshold rank. For example, the media guidance application may determine that only users with rankings in the top half of the group may have their respective user profiles updated.

In some embodiments, the media guidance application may compare (e.g., via control circuitry 304 (FIG. 3)) the first interaction level to a threshold interaction level and update the first user profile in response to determining that the first interaction level exceeds the threshold interaction level. For example, the media guidance application may determine that only users with interaction levels in the top half of the group may have their respective user profiles updated.

For example, the media guidance application may determine (e.g., via control circuitry 304 (FIG. 3)) that two users (e.g., a first user and a second user) are located in the viewing area of a display device using a detection module (e.g., detection module 316 (FIG. 3)). Furthermore, the media guidance application may determine (e.g., via control circuitry 304 (FIG. 3)) that the display device is current presenting a movie of the horror genre. The media guidance application may then determine an interaction level for both user. For example, the first user may be making frequent eye contact with the display device as well as holding a remote control for the display device (e.g., as detected using detection module 316 (FIG. 3)). Accordingly, the media guidance application may determine that the first user has a high interaction level (e.g., quantified by a particular percentage of interaction and/or other value). In contrast, the media guidance application may determine that the first user has a high interaction level (e.g., quantified by a particular percentage of interaction and/or other value).

The media guidance application may (e.g., via control circuitry 304 (FIG. 3)) then rank the first user and the second user based on their respective interaction levels. For example, the first user may have been assigned a value of eight (e.g., out of ten), whereas the second user may have been assigned a value of two (e.g., out of ten). For example, the media guidance application may have assigned (e.g., via control circuitry 304 (FIG. 3)) the first user eighty percent of the total amount associated with interaction with the display device and assigned the second user twenty percent of the total amount associated with the interaction with the display device. In another example, the media guidance application may have assigned the first user a value of two (corresponding to a high interaction level) and the second user a value of one or zero (e.g., corresponding to a low interaction level). In yet another example, the media guidance application may assign the first user a position (e.g., in an order of interaction) before the second user based on their respective interaction levels.

The media guidance application may then determine (e.g., via control circuitry 304 (FIG. 3)) a weight associated with the users based on the ranks. For example, if the ranks were denoted in percentages, the percentages may correspond to the weight for each user. For example, the first user may have been assigned a weight of eight (e.g., out of ten), whereas the second user may have been assigned a weight of two (e.g., out of ten). In another example, the media guidance application may have assigned the first user eighty percent of the total weight and assigned the second user twenty percent of the total weight. In another example, the media guidance application may have assigned the first user a weight of two (corresponding to a high interaction level and/or a high ranking) and the second user a weight of one or zero (e.g., corresponding to a low interaction level and/or low ranking). In yet another example, the media guidance application may assign the first user a high weight (e.g., a higher value of the weight) based on the position of the first user (e.g., in an order of interaction) of the first user as compared to the second user, which is assigned a low weight (e.g., a lower value of the weight) based on the position of the second user (e.g., in an order of interaction).

The media guidance application may then update (e.g., via control circuitry 304 (FIG. 3)) the user profile based on the interaction levels, ranks, and/or weights associated with the users. For example, as discuss in relation to FIG. 7, the media guidance application may update (e.g., via control circuitry 304 (FIG. 3)) a profile after determining an interaction level of the user, after determining a rank of the user, and/or after determining a weight associated with the rank of the user. In each case, the amount of the update to each user profile of a user may be based on that user's interaction level, rank, and/or weight.

For example, the media guidance application may determine (e.g., via control circuitry 304 (FIG. 3)) various attribute and/or characteristics about the media content currently being presented. For example, the media guidance application may determine a genre, an actor, a subject matter, etc. associated with the media content. The media guidance application may then update the user profile of each user in the viewing area to reflect that he or she viewed the media asset. The media guidance application may select a degree of the update that is unique to each user. For example, if the media guidance application determined (e.g., via control circuitry 304 (FIG. 3)) that the value of the interaction level, rank, and/or weight of associated with the first user was eighty percent (e.g., as discussed above), the media guidance application may only update the user profile by an amount that is equal to eighty percent of a degree to which the user profile would have been updated if the amount was equal to one-hundred percent.

For example, if the media guidance application employs a recommendation algorithm (e.g., used to recommend programs that a user may like based on information in the user profile), a value corresponding to one attribute (e.g., genre) in the user profile of the first user may only be raised by eighty percent of the total amount that the user profile would have been raised if the value was one-hundred percent if the value associated with the user was eight (e.g., as described above). In contrast, a value corresponding to the attribute (e.g., genre) in the user profile of the second user may be raised by twenty percent of the total amount that the user profile would have been raised if the value was one-hundred percent if the value associated with the user was two (e.g., as described above). Accordingly, the recommendation algorithm is more likely to recommend (e.g., via control circuitry 304 (FIG. 3)) media content with an attribute that is similar to the currently presented media asset for a first user (e.g., having a high interaction level) than the second user (e.g., having a high interaction level) because the user profile for the first user has been update more (e.g., to a greater degree) than the user profile for the second user.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one of more of the steps in FIG. 6.

FIG. 7 is a flowchart of illustrative steps for determining criteria upon which to base a decision on whether or not to update of a user profile. It should be noted that process 700 or any step thereof could be performed on, or provided by, any of the devices shown in FIGS. 3-4. For example, process 700 may be executed by control circuitry 304 (FIG. 3) as instructed by a media guidance application implemented on user equipment 402, 404, and/or 406 (FIG. 4) in order to determine criteria upon which to base a decision on whether or not to update a user profile. In addition, one or more steps of process 700 may be incorporated into or combined with one or more steps of any other process or embodiment (e.g., process 600 (FIG. 6)).

At step 702, the media guidance application determines (e.g., via control circuitry 304 (FIG. 3)) an interaction level of a user. For example, as described in step 604 (FIG. 6)), the media guidance application determines (e.g., via control circuitry 304 (FIG. 3)) a first interaction level for the first user and a second interaction level for the second user. For example, the media guidance application may determine (e.g., via control circuitry 304 (FIG. 3)) whether or not (and/or to what extent) the users are making eye contact, discussing the media content, using devices that may distract the users from the media content, controlling a device (e.g., a remote control) used to control the device upon which the media content is presented, etc. The media guidance application may use these determinations to arrive at an interaction level for each user.

At step 704, the media guidance application determines (e.g., via control circuitry 304 (FIG. 4)) whether or not an update to a user profile associated with the user is based on the interaction level. For example, in some embodiments, the media guidance application may determine whether or not a user profile is updated (and to what effect the user profile is updated) based on the interaction level of the user. For example, if the media guidance application determines that a user has a particular interaction level, the media guidance application may update the user profile in response. If the media guidance application determines to update the user profile associated with the user is based on the interaction level, the media guidance application proceeds to step 706. If the media guidance application determines not to update the user profile associated with the user based on the interaction level, the media guidance application proceeds to step 708.

At step 706, the media guidance application determines (e.g., via control circuitry 304 (FIG. 3)) an input based on the interaction level. For example, the media guidance application may quantify the interaction level into a value that can be imputed into a database (e.g., located at storage 308 (FIG. 3) and/or any location accessible via communications network 414 (FIG. 4)) in order to determine an effect (if any) that the value has on updating a user profile. The media guidance application then proceeds to step 716.

If the media guidance application determines not to update the user profile associated with the user based on the interaction level at step 704, the media guidance application proceeds to step 708. At step 708, the media guidance application determines a rank of the user based on the interaction level. For example, in order to determine how responsible the user is for the media content presented on a display device (e.g., display 312 (FIG. 3)), the media guidance application may compare the interaction level of the user to the interaction levels of other users. The media guidance application may then (e.g., via control circuitry 304 (FIG. 3)) quantify the comparison as a rank associated with each of the users. By quantifying the comparison in terms of a rank, the media guidance application may quantify the amount at which each user is responsible for the media content being presented by the display device.

Following step 708, the media guidance application proceeds to step 710. At step 710, the media guidance application determines whether or not an update to the user profile associated with the user is based on the rank of the user. If not, the media guidance application proceeds to step 714 and updates the user profile based on a default setting. For example, the default setting may cause the media guidance application to determine (e.g., via control circuitry 304 (FIG. 3)) that a user profile associated with a user will be updated based on the media content presented to the user irrespective of the number of users within a viewing area. Alternatively, the media guidance application may determine (e.g., via control circuitry 304 (FIG. 3)) that because the viewing area includes other users, the user profile of the user will not be updated based on the media content being presented.

If the media guidance application determines that the update of the user profile is based on the rank at step 710, the media guidance application proceeds to step 712. At step 712, the media guidance application determines (e.g., via control circuitry 304 (FIG. 3)) an input based on the rank. For example, as described in relation to step 706, the media guidance application may quantify the rank into a value that can be imputed into a database (e.g., located at storage 308 (FIG. 3) and/or any location accessible via communications network 414 (FIG. 4)) in order to determine an effect (if any) that the value has on updating a user profile. The media guidance application then proceeds to step 716.

At step 716, the media guidance application determines (e.g., via control circuitry 304 (FIG. 3)) whether or not to compare the input to a threshold value. For example, if the input corresponds to an interaction level of the user, the media guidance application may compare the interaction level of the user to a threshold interaction level. Alternatively, if the input corresponds to a rank of the user, the media guidance application may compare the rank to a threshold rank. In either case, the media guidance application may determine that any update to the user profile should only occur if the input exceeds a particular threshold. For example, if the interaction level and/or rank is low, the media guidance application may determine (e.g., via control circuitry 304 (FIG. 3)) that an update is not warranted. If the media guidance application determines to compare the input to a threshold, the media guidance application proceeds to step 720. If the media guidance application determines not to compare the input to a threshold, the media guidance application proceeds to step 718.

At step 718, the media guidance application cross-references the input with a database (e.g., located at storage 308 (FIG. 3) and/or any location accessible via communications network 414 (FIG. 4)). For example, the media guidance application may input the interaction level of the user into the database. The database may be populated with the amount (if any) a particular interaction level should have on a user profile of the user. For example, the database may receive amounts corresponding to each interaction level based on prior user history (e.g., of the current user and/or a group of users). Alternatively or additionally, the amounts may be based on any criteria (e.g., industry standards, consumer reviews, user trends, etc.).

In another example, the media guidance application may input the rank of the user into the database. The database may be populated with the amount (if any) a particular rank should have on a user profile of the user. For example, as discussed above, the database may receive amounts corresponding to each rank based on prior user history (e.g., of the current user and/or a group of users). Alternatively or additionally, the amounts may be based on any criteria (e.g., industry standards, consumer reviews, user trends, etc.). The media guidance application then proceeds to step 726 and updates the user profile based on the cross-reference.

If at step 716 the media guidance application determines to compare the input to a threshold, the media guidance application proceeds to step 720. At step 720, the media guidance application determines (e.g., via control circuitry 304 (FIG. 3)) whether or not the input exceeds the threshold. If the media guidance application determines that the input does not exceed the threshold, the media guidance application proceeds to step 724 and does not update the user profile. In contrast, if the media guidance application determines that the input does exceed the threshold, the media guidance application proceeds to step 722.

At step 722, the media guidance application cross-references the input with a database (e.g., located at storage 308 (FIG. 3) and/or any location accessible via communications network 414 (FIG. 4)). For example, as discussed in relation to step 718, the media guidance application may input the interaction level and/or rank of the user into the database. The database may be populated with the amount (if any) a particular interaction level and/or rank should have on a user profile of the user. For example, the database may receive amounts corresponding to each interaction level and/or rank based on prior user history, industry standards, consumer reviews, user trends, etc.).

At step 726, the media guidance application updates (e.g., via control circuitry 304 (FIG. 3)) the user profile of the user based on the cross-reference. For example, if the media guidance application determines the media content being presented to the user is a movie of the horror genre, the media guidance application may update the user profile based on the cross-reference. For example, the cross-reference may indicate that the interaction level and/or rank of the user indicates that the user profile should be weighted a particular amount. For example, if the interaction level and/or rank was low, the effect of the update to the user profile (indicating that the user viewed a horror movie) may be less than if the interaction level and/or rank was high.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one or more of the steps in FIG. 7.

The above-described embodiments of the present disclosure are presented for purposes of illustration and not of limitation, and the present disclosure is limited only by the claims that follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

1. A method for updating user profiles, the method comprising:
identifying a first user and a second user within a viewing area of media content;
determining a first interaction level for the first user and a second interaction level for the second user;
ranking the first user and the second user based on the first interaction level and the second interaction level;
determining a first weight based on the rank of the first user; and
updating a first user profile for the first user with information related to the media content, wherein a degree to which the first user profile is updated is based on the first weight.

2. The method of claim 1, further comprising:
determining a second weight based on the rank of the second user; and
updating a second user profile for the second user with information related to the media content, wherein a degree to which the second user profile is updated is based on the second weight.

3. The method of claim 1, wherein determining the first interaction level for the first user further comprises determining whether the first user is controlling a user device that is presenting the media content.

4. The method of claim 1, wherein determining the first interaction level for the first user further comprises determining whether a gaze point of the first user is fixated on a user device that is presenting the media content.

5. The method of claim 1, wherein determining the first interaction level for the first user further comprises determining whether the first user is discussing the media content.

6. The method of claim 1, wherein determining the first interaction level for the first user further comprises determining whether the first user is interacting with a user device that is not presenting the media content.

7. The method of claim 1, wherein determining the first interaction level for the first user further comprises determining whether the first user is controlling a user device presenting the media content.

8. The method of claim 1, further comprising:
comparing the rank of the first user to a threshold rank; and
updating the first user profile in response to determining that the rank of the first user exceeds the threshold rank.

9. The method of claim 1, further comprising:
cross-referencing the rank of the first user with a database listing degrees to which a user profile should be updated and a rank corresponding to each of the degrees to determine the degree to which the first user profile is updated.

10. The method of claim 1, further comprising:
comparing the first interaction level to a threshold interaction level; and
updating the first user profile in response to determining that the first interaction level exceeds the threshold interaction level.

11. A system for updating user profiles, the system comprising:
storage circuitry configured to store a first user profile for a first user; and
control circuitry configured to:
identify the first user and a second user within a viewing area of media content;
determine a first interaction level for the first user and a second interaction level for the second user;
rank the first user and the second user based on the first interaction level and the second interaction level;
determine a first weight based on the rank of the first user; and
update the first user profile for the first user with information related to the media content, wherein a degree to which the first user profile is updated is based on the first weight.

12. The system of claim 11, wherein the control circuitry is further configured to:
determine a second weight based on the rank of the second user; and
update a second user profile for the second user with information related to the media content, wherein a degree to which the second user profile is updated is based on the second weight.

13. The system of claim 11, wherein the control circuitry configured to determine the first interaction level for the first user is further configured to determine whether the first user is controlling a user device that is presenting the media content.

14. The system of claim 11, wherein the control circuitry configured to determine the first interaction level for the first user is further configured to determine whether a gaze point of the first user is fixated on a user device that is presenting the media content.

15. The system of claim 11, wherein the control circuitry configured to determine the first interaction level for the first user is further configured to determine whether the first user is discussing the media content.

16. The system of claim 11, wherein the control circuitry configured to determine the first interaction level for the first user is further configured to determine whether the first user is interacting with a user device that is not presenting the media content.

17. The system of claim 11, wherein the control circuitry configured to determine the first interaction level for the first user is further configured to determine whether the first user is controlling a user device presenting the media content.

18. The system of claim 11, wherein the control circuitry is further configured to:
compare the rank of the first user to a threshold rank; and
update the first user profile in response to determining that the rank of the first user exceeds the threshold rank.

19. The system of claim 11, wherein the control circuitry is further configured to:
cross-reference the rank of the first user with a database listing degrees to which a user profile should be updated and a rank corresponding to each of the degrees to determine the degree to which the first user profile is updated.

20. The system of claim 11, wherein the control circuitry is further configured to:
compare the first interaction level to a threshold interaction level; and
update the first user profile in response to determining that the first interaction level exceeds the threshold interaction level.

21-50. (canceled)
